(19) United States
(12) Patent Application Publication
(10) Pub. No.: US 2026/0027011 A1
(43) Pub. Date: Jan. 29, 2026

(54) INFUSION PREPARATION AND DELIVERY PLATFORM

(71) Applicant: CareFusion 303, Inc., San Diego, CA (US)

(72) Inventor: Jason Andrew WINE, Brea, CA (US)

(21) Appl. No.: 18/787,233

(22) Filed: Jul. 29, 2024

(51) Int. Cl. A61J 1/22; A61J 1/10; A61J 1/20

(52) U.S. Cl. CPC A61J 1/22; A61J 1/10; A61J 1/2089

(57) ABSTRACT

A device for preparing an intravenous (IV) infusion includes: a housing; a compounding assembly disposed within the housing, the compounding assembly includes a reconstitution apparatus configured to mix a diluent with a drug to create a reconstituted drug solution and an infusion apparatus that transfers the reconstituted drug solution to an infusion bag; a reconstitution volume adjustor engages the reconstitution apparatus to control an internal volume of the reconstitution apparatus; and an infusion volume adjustor engages the infusion apparatus to control an internal volume of the infusion apparatus.

### TECHNICAL FIELD

The present disclosure generally relates to infusion delivery and, in some embodiments, to a delivery platform for infusion preparation.

### SUMMARY

In certain embodiments, a device for preparing an intravenous (IV) infusion comprises: a housing; a compounding assembly disposed within the housing, the compounding assembly including a reconstitution apparatus configured to mix a diluent with a drug to create a reconstituted drug solution and an infusion apparatus for transferring the reconstituted drug solution to an infusion bag; a reconstitution volume adjustor configured to engage reconstitution apparatus to control an internal volume of the reconstitution apparatus; and an infusion volume adjustor configured to engage the infusion apparatus to control an internal volume of the infusion apparatus.

In certain embodiments, the device further comprises: an actuator disposed within the housing and configured to move at least one of the reconstitution volume adjustor and the infusion volume adjustor relative to the compounding assembly. In certain embodiments, the actuator moves away from the compounding assembly to decrease a pressure therein. In certain embodiments, the actuator moves toward from the compounding assembly to increase a pressure therein. In certain embodiments, the reconstitution volume adjustor is coupled to the reconstitution apparatus, and the infusion volume adjustor is coupled to the infusion apparatus.

In certain embodiments, the device further comprises: at least one valve operably connected to the compounding assembly, the valves configured to control flow of fluids within the reconstitution apparatus and the infusion apparatus. In certain embodiments, the at least one valve is an electrically activated valve controlled by a controller configured to open and close the valve. In certain embodiments, the at least one valve is a first valve, a second valve and a third valve configured to be operatively opened a closed to control flow of fluid within the reconstitution apparatus and the infusion apparatus. In certain embodiments, the first valve and the second valve are disposed between the reconstitution apparatus and a first vial and second vial, respectively. In certain embodiments, the third valve is disposed between the reconstitution apparatus and the infusion apparatus. In certain embodiments, the housing includes a front door that allows access to the compounding assembly.

In certain embodiments, a method for preparing an intravenous (IV) infusion using a compounding assembly having a reconstitution apparatus and an infusion apparatus, comprises: attaching a first vial to a first port on the reconstitution apparatus; attaching a second vial to a second port on the reconstitution apparatus opening a first valve disposed proximate the first port; creating a vacuum within the reconstitution apparatus to draw a liquid disposed in the first vial into the reconstitution apparatus; closing the first valve and opening a second valve disposed proximate the second port; compressing the reconstitution apparatus to transfer the liquid into the second vial; creating a vacuum within the reconstitution apparatus to draw a desired volume of reconstituted drug from the second vial into the reconstitution apparatus; closing the second valve; opening a third valve disposed between the reconstitution apparatus and an infusion apparatus; compressing the reconstitution apparatus to transfer the reconstituted drug into the infusion apparatus; closing the third valve; attaching a base fluid source to a third port on the infusion apparatus; and creating a vacuum within the infusion apparatus to draw a base fluid into the infusion apparatus.

In certain embodiments, the method further comprises: removing and discarding the reconstitution apparatus after the reconstituted drug is transferred to the infusion apparatus. In certain embodiments, the removal of the reconstitution subassembly is performed by one of tearing, cutting, or heat sealing. In certain embodiments, the heat sealing ensures the third valve is permanently closed.

In certain embodiments, the vacuum and compression is controlled by a controller configured to increases pressure or decreases pressure in the respective apparatus. In certain embodiments, the first valve, the second valve and the third valve are electrically activated clamping mechanisms. In certain embodiments, the compounding assembly is provided in a collapsed state with all practical air removed. In certain embodiments, the valve states are controlled by a controller configured to opens or close the respective valve. In certain embodiments, the base fluid is selected from the group consisting of saline, dextrose solution, and other compatible intravenous solutions.

### BRIEF DESCRIPTION OF THE DRAWINGS

The foregoing summary, as well as the following detailed description of embodiments of the device, will be better understood when read in conjunction with the appended drawings of an exemplary embodiment. It should be understood, however, that the invention is not limited to the precise arrangements and instrumentalities shown.

In the drawings:

FIG. 1 is a front perspective view of an IV infusion preparation device in accordance with an exemplary embodiment of the present disclosure;

FIG. 2 is a front view of the IV infusion preparation device of FIG. 1 with a first vial and second vial coupled thereto;

FIG. 3 is an exploded view of the IV infusion preparation device of FIG. 1;

FIG. 4A is a partial side cross-sectional view of the IV infusion preparation device of FIG. 1 showing the reconstitution volume adjustor in a disengaged configuration in a retracted position;

FIG. 4B is a partial side cross-sectional view of the IV infusion preparation device of FIG. 1 showing the reconstitution volume adjustor in an engaged configuration in a retracted position;

FIG. 4C is a partial side cross-sectional view of the IV infusion preparation device of FIG. 1 showing the reconstitution volume adjustor in an engaged configuration in an extended position;

FIG. 5A is a cross-sectional view of a valve of the IV infusion preparation device of FIG. 1 in a closed position;

FIG. 5B is a cross-sectional view of a valve of the IV infusion preparation device of FIG. 1 in an open position;

FIG. 6 is a front cross-sectional view of a compounding assembly of the IV infusion preparation device of FIG. 1 with a first vial coupled thereto in a first reconstitution apparatus filling configuration;

FIG. 7 is a front cross-sectional view of the compounding assembly of the IV infusion preparation device of FIG. 1 with a first vial and a second vial coupled thereto in a second vial filling configuration;

FIG. 8 is a front cross-sectional view of the compounding assembly of the IV infusion preparation device of FIG. 1 with a first vial and a second vial coupled thereto in a second reconstitution apparatus filling configuration;

FIG. 9 is a front cross-sectional view of the compounding assembly of the IV infusion preparation device of FIG. 1 with a first vial and a second vial coupled thereto in a first infusion apparatus filling configuration; and

FIG. 10 is a front cross-sectional view of the compounding assembly of the IV infusion preparation device of FIG. 1 with a first vial, a second vial and a base fluid source coupled thereto in a second infusion apparatus filling configuration.

### DETAILED DESCRIPTION

Intravenous (IV) infusion preparation and delivery commonly includes the use of several devices to prepare and administer a single infusion. Preparation and administration often includes drawing a diluent using a syringe, the drawn diluent is then added to a powdered medication in a separate vial, the mixture is then thoroughly mixed to ensure the powder is fully dissolved and evenly distributed within the diluent to create a solution, a required volume of the mixed solution is then drawn back into the syringe, and finally, the solution is either added to an IV bag or another syringe for administration to the patient. This process and others like it can include a number of devices, including vials, IV bags, needles and syringes for drawing and injecting fluids, and adapters to transfer fluid between vials and syringes without needles. These steps and tools are useful components during effective IV medication preparation and administration. However, the amount of waste that is created and the complexity of the process can be prohibitive to at-home infusion.

As such, there is a need for a simplified IV infusion preparation and delivery system that consolidates multiple steps and components of existing systems. A simplified device and system can reduce the number of disposable components, leading to cost savings and decreased environmental impact. Fewer handling steps and integrated automation can reduce the risk of contamination and errors during medication preparation and administration. A streamlined process can save time for healthcare providers, allowing them to focus more on patient care rather than manual preparation tasks.

Further, there is a need for an automated IV infusion preparation and delivery system. Automated drug compounding minimizes the manual steps required by pharmacy technicians. This can lead to significant time savings and reduce the labor required for preparing infusions. Automation ensures consistent preparation processes, enhancing overall efficiency. Automating the compounding process significantly reduces the risk of exposure to hazardous drugs for healthcare workers. This is particularly important in the preparation of chemotherapy drugs and other cytotoxic agents, where safety is paramount.

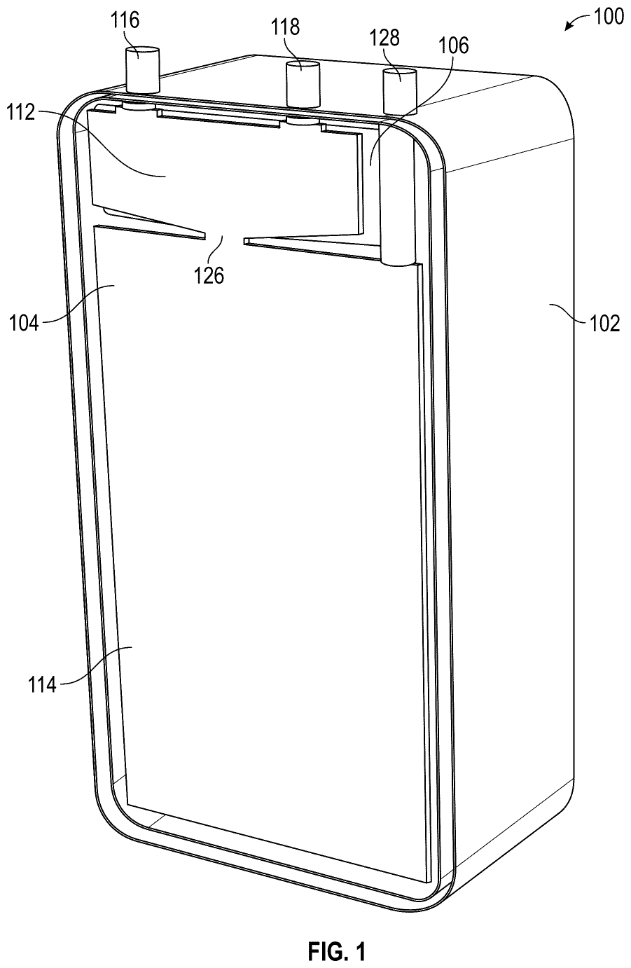

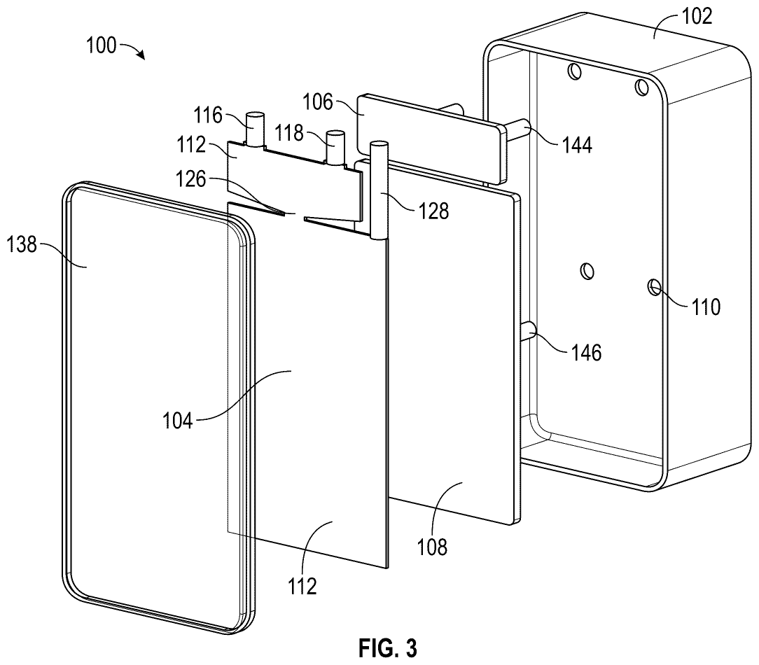

Referring to the drawings in detail, wherein like reference numerals indicate like elements throughout, there is shown in FIGS. 1-10 an intravenous (IV) infusion preparation device, generally designated 100, in accordance with an exemplary embodiment of the present invention.

As shown in FIGS. 1-3, the intravenous (IV) infusion preparation device 100 may include a housing 102, a compounding assembly 104, a reconstitution volume adjustor 106 and an infusion volume adjustor 108. The housing 102 may define an internal volume shaped and sized to receive the compounding assembly 104, the reconstitution volume adjustor 106 and the infusion volume adjustor 108. The housing 102 may have five closed faces and one open face to allow the remaining components of the device 100 to be disposed therein. The housing 102 may have an open front side. The rear side opposite the front side may include at least one adjustor aperture 110 extending therethrough. The adjustor aperture 110 may be shaped and sized to allow a portion of the reconstitution volume adjustor 106 and/or the infusion volume adjustor 108 to pass therethrough. The reconstitution volume adjustor 106 and/or the infusion volume adjustor 108 may be moveable relative to the adjustor aperture 110. The housing 102 may include a door 138 removably coupled to the open face. The door 138 may be coupled to the front face. The door 138 may be removeable to allow access to the components disposed within the housing 102. The door 138 may be pivotably coupled to one side of the open face to allow the door 138 to pivot relative to the housing 102.

The compounding assembly 104 may combines the functions of compounding and delivery. The compounding assembly 104 may include two main components, a reconstitution apparatus 112 and an infusion apparatus 114. The reconstitution apparatus 112 may be configured to mix a diluent with a drug to create a reconstituted drug solution, ensuring the drug is properly dissolved and homogenized before administration. The infusion apparatus 114 may be configured to transfer the reconstituted drug solution to an infusion bag, which can then be used for IV administration to a patient.

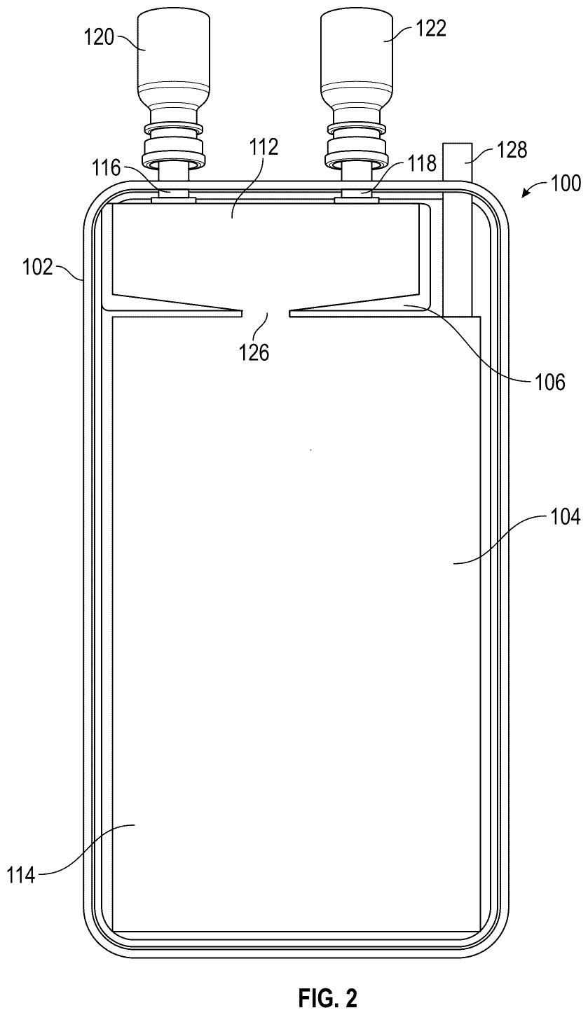

The reconstitution apparatus 112 may be made from a flexible material allowing it to transition between the collapsed state with minimal air content and an expanded state with a volume of air disposed between its flexible walls. The reconstitution apparatus 112 may be a flexible bag or bladder. The reconstitution apparatus 112 may include a first valve 116 and a second valve 118 disposed thereon. The first valve 116 and the second valve 118 may selectively allow fluid to pass therethrough and into or out of the reconstitution apparatus 112. The first valve 116 may extend from the reconstitution apparatus 112 and may be configured to receive a first vial 120 (FIG. 2) thereon. The second valve 1168 may extend from the reconstitution apparatus 112 and may be configured to receive a second vial 122 (FIG. 2) thereon.

The infusion apparatus 114 may be made from a flexible material allowing it to transition between the collapsed state with minimal air content and an expanded state with a volume of air disposed between its flexible walls. The infusion apparatus 114 may be a flexible bag or bladder. A third valve 126 may be disposed between the reconstitution apparatus 112 and the infusion apparatus 114. The third valve 126 may be configured to selectively allow fluid to pass therethrough between the reconstitution apparatus 112 and the infusion apparatus 114. The infusion apparatus 114 may include a fourth valve 128 disposed thereon. The fourth valve 128 may extend from the infusion apparatus 114 and may be configured to receive a base fluid source 130 (not shown) thereon.

The first valve 116, the second valve 118, the third valve 126 and the fourth valve 128 may be electrically activated valves. These valves may control the flow of fluids into and out of the reconstitution apparatus 112 and infusion apparatus 114, as applicable, opening and closing at precise intervals to direct the flow as needed. The use of electrically activated valves may enhance the precision and reliability of the fluid handling process. The first valve 116, the second valve 118, the third valve 126 and the fourth valve 128 may be controlled by a controller 124 (e.g., a central processing unit (CPU)) that automates their operation based on pre-programmed instructions. This automation reduces the need for manual intervention, ensuring consistent and repeatable compounding processes, and enhancing overall device reliability.

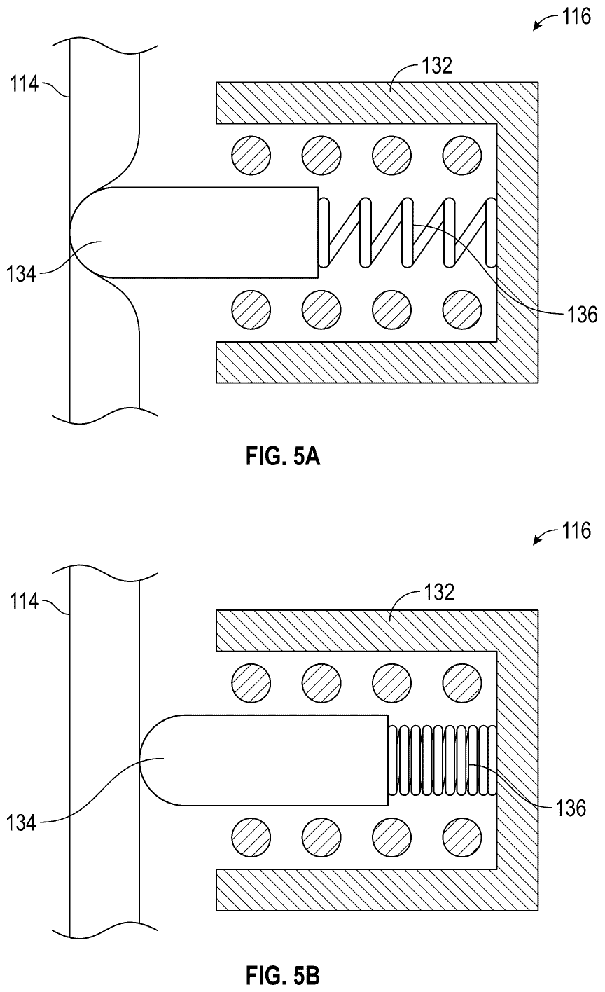

A shown in FIGS. 5A and 5B, the first valve 116 may be moveable between an open position (FIG. 5B) where a fluid is allowed to pass therethrough and a closed position (FIG. 5A) where a fluid is prevented from passing therethrough and a closed position. The first valve 116 may include a valve body 132, a valve hammer 134 moveable relative to the valve body 132 between a blocking position and an unblocking position, and a valve spring 136 configured to move the valve hammer 134 between the blocking position and the unblocking position. The valve hammer 134 may engage the reconstitution apparatus 112 to prevent fluid from passing therethrough. While FIGS. 5A and 5B illustrate the first valve 116, it should be appreciated that the second valve 118, the third valve 126 and the fourth valve 128 may have largely identical configurations.

To precisely control the volumes within the reconstitution apparatus 112 and/or infusion apparatus 114, the device 100 may include a reconstitution volume adjustor 140 and an infusion volume adjustor 142 disposed within the housing 102. The reconstitution volume adjustor 140 may engage the reconstitution apparatus 112 to adjust its internal volume. This may ensure accurate measurement and mixing of the diluent and drug therein. Similarly, the infusion volume adjustor 142 may engage with the infusion apparatus 114 to control the volume of the reconstituted drug solution being transferred therein.

The reconstitution volume adjustor 140 may include a first extension 144 extending therefrom. The first extension 144 may extend in an opposite direction to the surface that engages the reconstitution apparatus 112. The first extension 144 may be shaped and sized to fit through the aperture 110 in the housing 102. The first extension 144 may be engaged by an actuator 146 configured to move the reconstitution volume adjustor 140 relative to the housing 102.

The infusion volume adjustor 142 may include a second extension 148 extending therefrom. The second extension 148 may extend in an opposite direction to the surface that engages infusion apparatus 114. The second extension 148 may be shaped and sized to fit through the aperture 110 in the housing 102. The second extension 148 may be engaged by an actuator 146 configured to move the infusion volume adjustor 142 relative to the housing 102.

The actuator 146 may comprise a motor or linear actuator that moves the reconstitution volume adjustor 140 to a position corresponding to the intended fill volume of the reconstitution apparatus 112. The actuator 146 ensures precise control over the volume of the diluent and drug mixture, which is crucial for accurate and effective reconstitution of the drug.

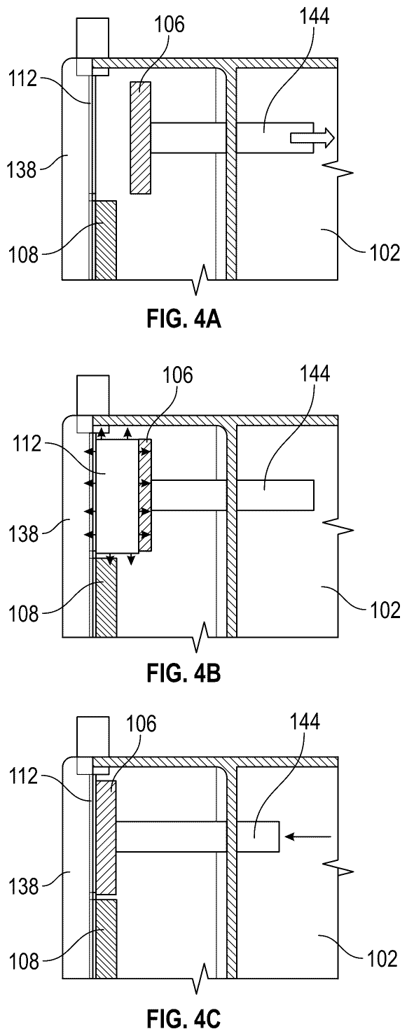

As shown in FIGS. 4A-4C, the reconstitution volume adjustor 140 may be moveable between a disengaged configuration where the reconstitution volume adjustor 140 is at least temporarily coupled to the reconstitution apparatus 112 and a disengaged configuration where the reconstitution volume adjustor 140 is not coupled to the reconstitution apparatus 112. The reconstitution volume adjustor 140 may also be moveable between a retracted position where the reconstitution volume adjustor 140 is spaced apart from the door 138 of the housing 102 and an extended position where the reconstitution volume adjustor 140 is positioned proximate the door 138. The reconstitution volume adjustor 140 may be moveable by the actuator 146 between the retracted position and the extended position. The reconstitution volume adjustor 140 may have a coupling material (e.g., glue or epoxy) disposed on a front end that is configured to couple the reconstitution volume adjustor 140 to the reconstitution apparatus 112 thereby moving the reconstitution volume adjustor 140 into the engaged configuration.

The reconstitution volume adjustor 140 in the engaged position (FIG. 4B) may enable the controller 124 to move the reconstitution volume adjustor 140 to increase or decrease pressure to decrease or increase the internal volume of the reconstitution apparatus 112, respectively. Depending on the status of the first valve 116 or the second valve 118, the volume of the reconstitution apparatus 112 may receive air or fluid therethrough if either is in the open position and the reconstitution volume adjustor 140 is in the engaged configuration and moved from the extended position to the retracted position.

The creation of a pressure differential is essential for drawing in fluid and transferring the fluid. Typical pressure ranges in these systems can vary widely depending on the specific design and requirements of the IV preparation process. The reconstitution apparatus 112 may operate under negative pressure (vacuum) conditions to draw in diluents and facilitate the reconstitution of lyophilized drugs. A vacuum of −10 to −15 psi may be sufficient to ensure efficient fluid intake without causing damage to the apparatus or the fluids. For example, a vacuum chamber maintained at −10 psi can create enough suction to draw a fluid from a vial into the reconstitution apparatus 112, ensuring that the fluid enters smoothly and mixes thoroughly with the drug. Positive pressure is applied to facilitate the transfer of the reconstituted drug solution from the reconstitution apparatus 112 to the infusion apparatus 114. This positive pressure can range from 5 to 15 psi, depending on the viscosity of the solution and the resistance of the flow path. For example, applying a positive pressure of 6 psi can achieve a flow rate of approximately 12-14 liters per hour through standard IV tubing, which is sufficient to fill a 1000 mL infusion bag in about 5 minutes.

While the reconstitution volume adjustor 140 is shown in FIGS. 4A-4C it should be appreciated that the infusion volume adjustor 142 is configured to interact and engage the infusion apparatus 114 in the same manner and may cause the internal volume thereof to increase or decrease by movement of the actuator. The third valve 126 and the fourth valve 128 status may determine whether the infusion apparatus 114 is filled or emptied with liquid or air.

The actuator 146 may be controlled by a user interface that allows the operator to input the desired fill volume. The user interface may provide an intuitive and easy-to-use platform for setting and monitoring the compounding process, enhancing the accuracy and efficiency of the device.

A method of using the device 100 to provide a simplified IV infusion preparation and delivery may be disclosed. The method may include two main phases, preparation and delivery.

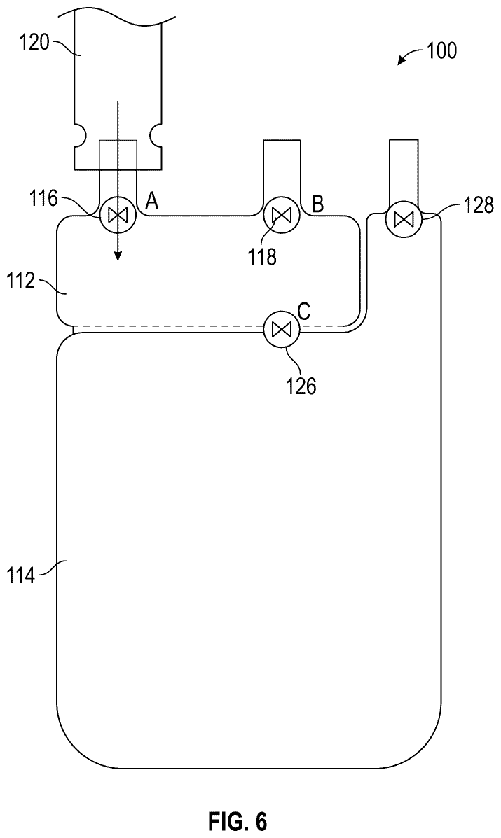

The preparation phase may involve the compounding apparatus 112 primarily. The compounding apparatus 112 can be used to mix (compound) the medication and can also serve as the delivery medium for the infusion. This multi-functional use can reduce the need for multiple separate containers and can minimize the risk of contamination and errors during the transfer of the medication. As shown in FIG. 6, the method may include the user attaching the first vial 120 (e.g., a diluent source) to the compounding apparatus 112. The controller 124 may automatically open the first valve 116 and control the actuator 146 to move the reconstitution volume adjustor 140 from the retracted position to the extended position to couple to the reconstitution apparatus 112 and then once in the engaged configuration back toward the retracted position to decrease the pressure within the reconstitution apparatus 112 to draw a volume of the fluid from the first vial 120 therein. In some embodiments, the reconstitution volume adjustor 140 is in the engaged configuration when provided, and the reconstitution volume adjustor 140 is moved from the expanded position toward the retracted position. This automated process enhances safety, accuracy, and efficiency in the preparation of the IV infusion. The first vial 120 may be coupled to the first valve 116 using a vented or protected vial adapter to ensure that air can be drawn into the bag portion before drawing the diluent.

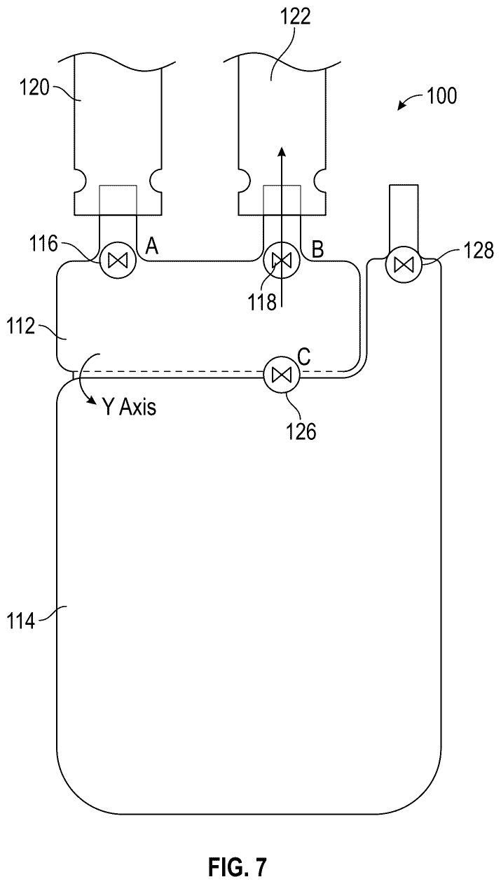

As shown in FIG. 7, the method may include transferring the fluid from the first vial 120 (e.g., diluent) into the second vial 122 (e.g., a lyophilized drug vial). The controller 124 may close the first valve 116 and open the second valve 118 to prepare for the transfer. The actuator 146 may then move the reconstitution volume adjustor 140 from the retracted position into the expanded position to increase the pressure within the reconstitution apparatus 112 and eject the volume of fluid into the second vial 122. This automated and precise process ensures accurate reconstitution of the drug, enhancing safety and efficiency in medication preparation. The connection to the second vial 122 may be made using a vented or protected vial adapter. Air from the second vial 122 may be allowed to enter the reconstitution apparatus 112 to balance the pressure and facilitate the fluid transfer. If inversion is required, the entire compounding assembly 104 can be adjusted, or the reconstitution apparatus 112 can be folded relative to the infusion apparatus 114.

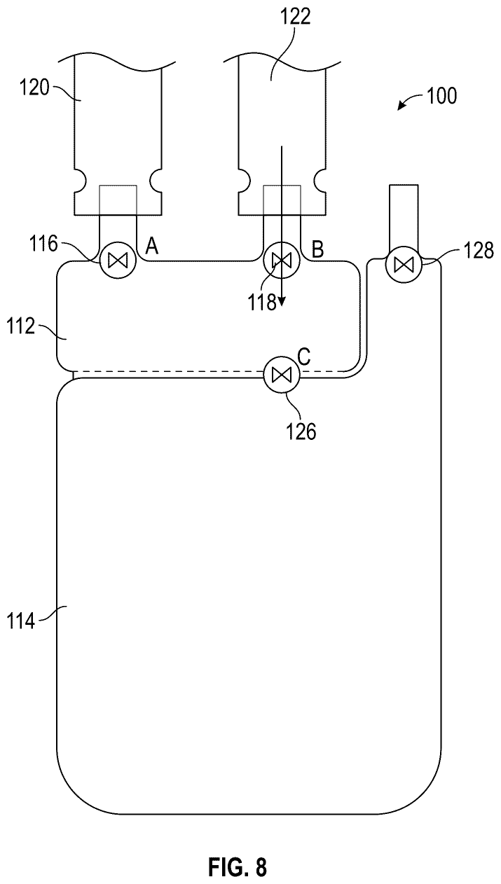

As shown in FIG. 8, the method may include transferring the reconstituted drug from the second vial 122 into the reconstitution apparatus 112. With the second valve 118 open, the controller 124 may control the actuator 146 to move the reconstitution volume adjustor 140 from the expanded position to the retracted position to decrease the pressure within the reconstitution apparatus 112 and draw the precise desired volume of the reconstituted drug into the reconstitution apparatus 112. Precise control of the second valve 118 ensures that the reconstituted drug is drawn accurately from the second vial 122 into the reconstitution apparatus 112.

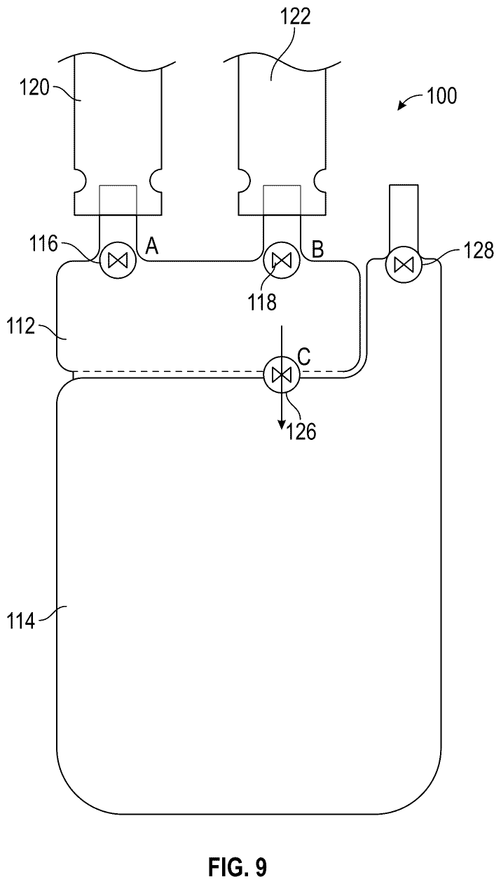

As shown in FIG. 9, the method may include transferring the reconstituted drug from the reconstitution apparatus 112 to the infusion apparatus 114. The controller 124 may close the second valve 118 and open the third valve 126 to prepare for the transfer. The actuator 146 may then move the reconstitution volume adjustor 140 from the retracted position into the expanded position to increase the pressure within the reconstitution apparatus 112 and eject the volume of fluid into the infusion apparatus 114. In some embodiments, the actuator may move the infusion volume adjustor 142 from the expanded position toward a retracted position to decrease the pressure and draw the volume of the reconstituted drug from the reconstitution apparatus 112 into the infusion apparatus 114.

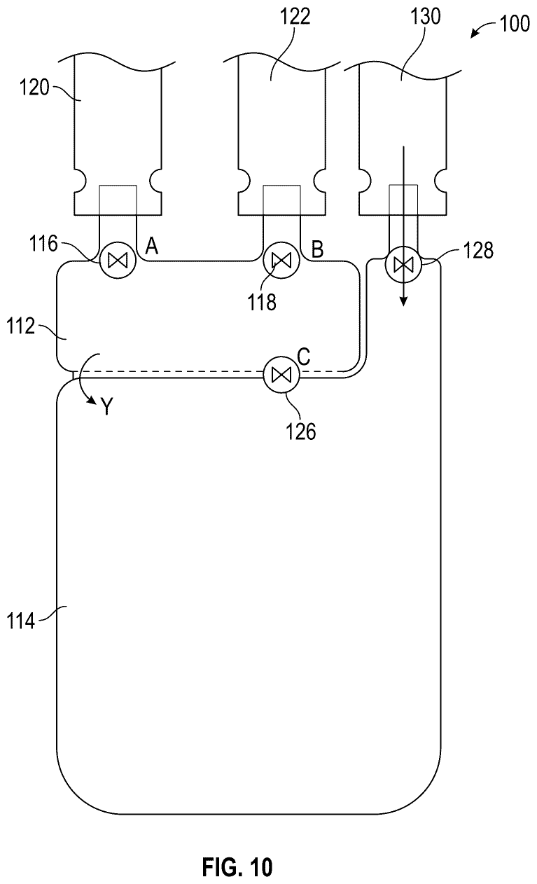

As shown in FIG. 10, the method may include transferring a volume of base fluid (e.g., saline) into the infusion apparatus 114. The controller 124 may close the third valve 126 and open the fourth valve 128 to prepare for the base fluid draw. The actuator 146 may then move the infusion volume adjustor 142 from the expanded position toward a retracted position to decrease the pressure and draw the volume of the base fluid from the base fluid source 130 into the infusion apparatus 114. After the base fluid is received in the infusion apparatus 114, the reconstitution apparatus 112 may be removed and discarded. This can be done by tearing, cutting, or heat sealing the section containing the reconstitution apparatus 112. Heat sealing would also ensure that the third valve 126 is permanently closed, maintaining the integrity of the infusion apparatus 114.

In one embodiment, the device includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

### Illustration of Subject Technology as Clauses

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 12. The other clauses can be presented in a similar manner.

Clause 1: A device for preparing an intravenous (IV) infusion comprising: a housing; a compounding assembly disposed within the housing, the compounding assembly including a reconstitution apparatus configured to mix a diluent with a drug to create a reconstituted drug solution and an infusion apparatus for transferring the reconstituted drug solution to an infusion bag; a reconstitution volume adjustor configured to engage reconstitution apparatus to control an internal volume of the reconstitution apparatus; and an infusion volume adjustor configured to engage the infusion apparatus to control an internal volume of the infusion apparatus.

Clause 2: The device of clause 1, further comprising: an actuator disposed within the housing and configured to move at least one of the reconstitution volume adjustor and the infusion volume adjustor relative to the compounding assembly.

Clause 3: The device of clause 2, wherein the actuator moves away from the compounding assembly to decrease a pressure therein.

Clause 4: The device of clause 2, wherein the actuator moves toward from the compounding assembly to increase a pressure therein.

Clause 5: The device of clause 1, wherein the reconstitution volume adjustor is coupled to the reconstitution apparatus, and wherein the infusion volume adjustor is coupled to the infusion apparatus.

Clause 6: The device of clause 1, further comprising: at least one valve operably connected to the compounding assembly, the valves configured to control flow of fluids within the reconstitution apparatus and the infusion apparatus.

Clause 7: The device of clause 6, wherein the at least one valve is an electrically activated valve controlled by a controller configured to open and close the valve.

Clause 8: The device of clause 7, wherein the at least one valve is a first valve, a second valve and a third valve configured to be operatively opened a closed to control flow of fluid within the reconstitution apparatus and the infusion apparatus.

Clause 9: The device of clause 8, wherein the first valve and the second valve are disposed between the reconstitution apparatus and a first vial and second vial, respectively.

Clause 10: The device of clause 8, wherein the third valve is disposed between the reconstitution apparatus and the infusion apparatus.

Clause 11: The device of clause 1, wherein the housing includes a front door that allows access to the compounding assembly.

Clause 12: A method for preparing an intravenous (IV) infusion using a compounding assembly having a reconstitution apparatus and an infusion apparatus, comprising: attaching a first vial to a first port on the reconstitution apparatus; attaching a second vial to a second port on the reconstitution apparatus opening a first valve disposed proximate the first port; creating a vacuum within the reconstitution apparatus to draw a liquid disposed in the first vial into the reconstitution apparatus; closing the first valve and opening a second valve disposed proximate the second port; compressing the reconstitution apparatus to transfer the liquid into the second vial; creating a vacuum within the reconstitution apparatus to draw a desired volume of reconstituted drug from the second vial into the reconstitution apparatus; closing the second valve; opening a third valve disposed between the reconstitution apparatus and an infusion apparatus; compressing the reconstitution apparatus to transfer the reconstituted drug into the infusion apparatus; closing the third valve; attaching a base fluid source to a third port on the infusion apparatus; and creating a vacuum within the infusion apparatus to draw a base fluid into the infusion apparatus.

Clause 13: The method of Clause 12, further comprising: removing and discarding the reconstitution apparatus after the reconstituted drug is transferred to the infusion apparatus.

Clause 14: The method of Clause 13, wherein the removal of the reconstitution subassembly is performed by one of tearing, cutting, or heat sealing.

Clause 15: The method of Clause 14, wherein the heat sealing ensures the third valve is permanently closed.

Clause 16: The method of Clause 12, wherein the vacuum and compression is controlled by a controller configured to increases pressure or decreases pressure in the respective apparatus.

Clause 17: The method of Clause 12, wherein the first valve, the second valve and the third valve are electrically activated clamping mechanisms.

Clause 18: The method of Clause 12, wherein the compounding assembly is provided in a collapsed state with all practical air removed.

Clause 19: The method of Clause 12, wherein the valve states are controlled by a controller configured to opens or close the respective valve.

Clause 20: The method of Clause 12, wherein the base fluid is selected from the group consisting of saline, dextrose solution, and other compatible intravenous solutions.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

In one aspect, the term “coupled” or the like may refer to being directly coupled. In another aspect, the term “coupled” or the like may refer to being indirectly coupled.

Terms such as “top,” “bottom,” “front,” “rear” and the like if used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Various items may be arranged differently (e.g., arranged in a different order, or partitioned in a different way) all without departing from the scope of the subject technology. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A device for preparing an intravenous (IV) infusion comprising:
a housing;
a compounding assembly disposed within the housing, the compounding assembly including a reconstitution apparatus configured to mix a diluent with a drug to create a reconstituted drug solution and an infusion apparatus for transferring the reconstituted drug solution to an infusion bag;
a reconstitution volume adjustor configured to engage reconstitution apparatus to control an internal volume of the reconstitution apparatus; and
an infusion volume adjustor configured to engage the infusion apparatus to control an internal volume of the infusion apparatus.

2. The device of claim 1, further comprising:
an actuator disposed within the housing and configured to move at least one of the reconstitution volume adjustor and the infusion volume adjustor relative to the compounding assembly.

3. The device of claim 2, wherein the actuator moves away from the compounding assembly to decrease a pressure therein.

4. The device of claim 2, wherein the actuator moves toward from the compounding assembly to increase a pressure therein.

5. The device of claim 1, wherein the reconstitution volume adjustor is coupled to the reconstitution apparatus, and
wherein the infusion volume adjustor is coupled to the infusion apparatus.

6. The device of claim 1, further comprising:
at least one valve operably connected to the compounding assembly, the valves configured to control flow of fluids within the reconstitution apparatus and the infusion apparatus.

7. The device of claim 6, wherein the at least one valve is an electrically activated valve controlled by a controller configured to open and close the valve.

8. The device of claim 7, wherein the at least one valve is a first valve, a second valve and a third valve configured to be operatively opened a closed to control flow of fluid within the reconstitution apparatus and the infusion apparatus.

9. The device of claim 8, wherein the first valve and the second valve are disposed between the reconstitution apparatus and a first vial and second vial, respectively.

10. The device of claim 8, wherein the third valve is disposed between the reconstitution apparatus and the infusion apparatus.

11. The device of claim 1, wherein the housing includes a front door that allows access to the compounding assembly.

12. A method for preparing an intravenous (IV) infusion using a compounding assembly having a reconstitution apparatus and an infusion apparatus, comprising:
attaching a first vial to a first port on the reconstitution apparatus;
attaching a second vial to a second port on the reconstitution apparatus
opening a first valve disposed proximate the first port;
creating a vacuum within the reconstitution apparatus to draw a liquid disposed in the first vial into the reconstitution apparatus;
closing the first valve and opening a second valve disposed proximate the second port;
compressing the reconstitution apparatus to transfer the liquid into the second vial;
creating a vacuum within the reconstitution apparatus to draw a desired volume of reconstituted drug from the second vial into the reconstitution apparatus;
closing the second valve;
opening a third valve disposed between the reconstitution apparatus and an infusion apparatus;
compressing the reconstitution apparatus to transfer the reconstituted drug into the infusion apparatus;
closing the third valve;
attaching a base fluid source to a third port on the infusion apparatus; and
creating a vacuum within the infusion apparatus to draw a base fluid into the infusion apparatus.

13. The method of claim 12, further comprising:
removing and discarding the reconstitution apparatus after the reconstituted drug is transferred to the infusion apparatus.

14. The method of claim 13, wherein the removal of the reconstitution subassembly is performed by one of tearing, cutting, or heat sealing.

15. The method of claim 14, wherein the heat sealing ensures the third valve is permanently closed.

16. The method of claim 12, wherein the vacuum and compression is controlled by a controller configured to increases pressure or decreases pressure in the respective apparatus.

17. The method of claim 12, wherein the first valve, the second valve and the third valve are electrically activated clamping mechanisms.

18. The method of claim 12, wherein the compounding assembly is provided in a collapsed state with all practical air removed.

19. The method of claim 12, wherein the valve states are controlled by a controller configured to opens or close the respective valve.

20. The method of claim 12, wherein the base fluid is selected from the group consisting of saline, dextrose solution, and other compatible intravenous solutions.
